(19) United States
(12) Patent Application Publication
(10) Pub. No.: US 2018/0117858 A1
(43) Pub. Date: May 3, 2018

(54) HOLLOW WALL COMPOSITE TUBE, METHODS OF PRODUCTION AND USES THEREOF

(71) Applicant: Robert Burch Fraidenburgh, Woodside, CA (US)

(72) Inventor: Robert Burch Fraidenburgh, Woodside, CA (US)

(21) Appl. No.: 15/796,820

(22) Filed: Oct. 29, 2017

Related U.S. Application Data
(63) Continuation-in-part of application No. 14/480,421, filed on Sep. 8, 2014, now Pat. No. 9,802,365.
Application No. 14/480,421 is a continuation of application No. 13/763,661, filed on Feb. 9, 2013.
(60) Provisional application No. 61/606,186, filed on Mar. 2, 2012.
(60) Provisional application No. 61/656,010, filed on Jun. 6, 2012.
(60) Provisional application No. 61/671,700, filed on Jul. 14, 2012.

(51) Int. Cl. B29C 70/30; A63B 53/10; B29L 31/52; B29L 24/00; B29L 23/00; B29K 307/04; B29K 63/00; A63C 11/22

(52) U.S. Cl. CPC B29C 70/30; B32B 2363/00; A63B 60/06; B29L 2031/52; B29L 2024/00; B29L 2023/22; B29K 2307/04; B29K 2063/00; A63C 11/227; A63B 2209/02; A63B 59/70; Y10T 428/1369; Y10T 428/1362; Y10T 428/13; B32B 2597/00; A63B 53/10

(57) ABSTRACT

Hollow wall curable and cured composite tubes for improving performance in sports shafts, lightweight applications, and lightweight structural members, are described herein and include: a constituent tube, for forming the hollow wall composite tube, that comprises an evacuable flexible core component on which to wind or braid filaments or fabric, and at least one braid filament or at least one fabric for providing a reinforcing fiber matrix for saturation with an epoxy material, spirally wrapped, applied or braided on the flexible core component. Methods for producing and using the same are also disclosed herein.

This United States Continuation in Part application claims priority to U.S. application Ser. No. 14/480,421 filed on Sep. 8, 2014, which is a continuation in part of U.S. application Ser. No. 13/763,661 filed on Feb. 9, 2013, which claims priority to U.S. Provisional Application Ser. No. 61/606,186 filed on Mar. 2, 2012; U.S. Provisional Application Ser. No. 61/656,010 filed on Jun. 6, 2012; and U.S. Provisional Application Ser. No. 61/671,700 filed on Jul. 14, 2012, all of which are commonly-owned and incorporated by reference in their entirety.

### FIELD OF THE SUBJECT MATTER

The contemplated embodiments and subject matter disclosed herein relates to composite tubing and products made from composite tubing and, more particularly, to tubular items in which strength and weight are at a premium. Golf club shafts, tennis rackets, ski poles, hockey sticks, fishing rods, and arrows are some examples; however other applications of the composite tubing are contemplated. Contemplated embodiments also relate to lightweight structural members used in aerospace, sailboats, automobiles, and bicycles.

### BACKGROUND

Composite tubing is used for many products, because of its high strength-to-weight ratio. When more strength is desired in a composite tube, options are limited. Material can be upgraded and wall thickness can be increased. When less weight is desired, wall thickness can be decreased, or holes can be added through the wall. Also, a standard composite tube is configured exactly like a tubular bell. Having a single, solid wall like a bell creates maximum vibration after striking an object or flexural release. It also transmits vibration most efficiently to the human hand and adjacent bone structure, or in the case of an assembly, to the connecting components.

Other solutions have involved substituting higher modulus fiber (generally carbon fiber), wrapping with filament or fabric at varying angles to create biased piles, using higher stiffness epoxy to increase strength, and decreasing wall thickness to decrease weight.

Decreasing wall thickness to reduce weight can have catastrophic results. A single unsupported wall is subject to distortion, vibration, buckling, even cracking and splitting. Increasing strength by thickening the wall adds weight. Changing material can increase strength, but within narrow limits. Changing material can increase cost.

Therefore, it would be ideal to develop and utilize a one-piece composite tube having a hollow inner core bordered by a wall, wherein the outside and inside surfaces, along with the ends of the tube, may have standard surfaces and shapes suitable for bonding or fastening. Ideal composite tubes would have a hollow wall for light weight and strength, be resistant to vibration, while maintaining light weight, and would be resistant to distortion when flexed, loaded, or subject to torque.

### SUMMARY OF THE SUBJECT MATTER

Hollow wall composite tubes for improving performance in sports shafts, lightweight applications, and lightweight structural members, are described herein and include: a constituent tube, for forming the hollow wall composite tube, that comprises an evacuable flexible core component on which to wind or braid filaments or fabric, and at least one braid filament or at least one fabric for providing a reinforcing fiber matrix for saturation with an epoxy material, spirally wrapped, applied or braided on the flexible core component. In some embodiments, hollow wall composite tubes are utilized for or as part of an aerospace component, a sailboat, an automobile, or a bicycle.

A method of making a curable hollow wall composite tube for improving performance in sports shafts, lightweight applications, and lightweight structural members includes: providing a constituent tube for forming the wall that comprises: an evacuable flexible core component on which to wind or braid filaments or fabric; providing at least one two, at least one braid filament or at least one fabric for providing a reinforcing fiber matrix for saturation with an epoxy material, spirally wrapped, applied or braided on the flexible core component; and wrapping, applying or braiding two, braid filaments or fabric on to the flexible core component. In some embodiments, the method further comprises: providing a mandrel; wrapping the constituent tube around the mandrel, so that the tube forms an internal surface that has a shape similar to the mandrel; and removing the mandrel to form the curable composite tube. In other embodiments, contemplated methods further comprise applying to or saturating the at least one braid filament or at least one fabric with an epoxy material. In yet other embodiments, contemplated methods further comprise curing the curable composite tube.

### BRIEF DESCRIPTION OF THE FIGURES

FIG. 1 is a section view of a hollow wall composite tube.

FIG. 2 is a perspective view of a flexible, shaped core, spiral wrapped with fiber or fabric, then spiral wrapped around a removable mandrel.

FIG. 3 is a perspective view of a finished hollow wall composite tube with the hollow wall on one end exposed in detail.

FIG. 4 is a section view of a contemplated hollow wall composite tube.

FIG. 5 shows a contemplated method.

FIG. 6 shows a section view of a contemplated composite tube fabric that has not been hardened or cured yet.

FIG. 7 shows a contemplated method.

### DETAILED DESCRIPTION

According to disclosed and contemplated embodiments, a composite tube, wherein it has a one-piece configuration, but may have several layers, having a hollow core bounded by a wall has been developed, wherein the outside and inside surfaces, along with the ends of the tube, may have standard surfaces and shapes suitable for bonding or fastening. Contemplated composite tubes have a hollow core bounded by a wall for light weight and strength, are resistant to vibration, while maintaining light weight, and are resistant to distortion when flexed, loaded, or subjected to torque. As used herein, a contemplated hollow core bounded by a wall is referred to herein

Specifically, a curable hollow wall composite tube for improving performance in sports shafts, lightweight applications, and lightweight structural members is disclosed that includes: a constituent tube for forming the hollow wall composite tube, that comprises an evacuable flexible core component on which to wind or braid filaments or fabric, and at least one braid filament or at least one fabric for providing a reinforcing fiber matrix for saturation with an epoxy material, spirally wrapped, applied or braided on the flexible core component. In some embodiments, an epoxy material is also included that is applied to or saturates the at least one braid filament or at least one fabric.

As used herein, the term “curable” with respect to the hollow wall composite tube means that it can be further heated, illuminated, or otherwise cured in order to transform the epoxy from a small molecule material into one that is polymeric or a larger molecule material that can be harder, stronger, more durable, less tacky, or a combination thereof.

As used herein, the term “evacuable” when applied to the flexible core component means that it can be melted, dissolved, or otherwise forced out entirely. In some contemplated embodiments, the flexible core component may be heated and then at least partially removed with the remainder of the core remaining behind to coat and/or reinforce the inside surface of the constituent tube.

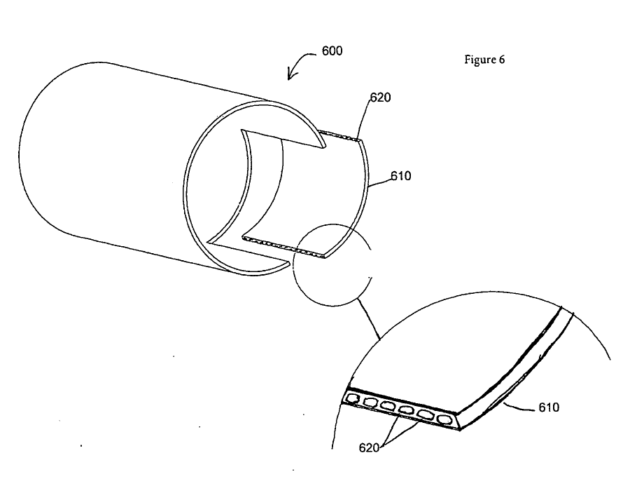

Hollow wall composite tubes for improving performance in sports shafts, lightweight applications, and lightweight structural members, are described herein, shown in FIG. 6 and include: a constituent tube 600, for forming the hollow wall composite tube, that comprises an evacuable flexible core component 620 on which to wind or braid filaments or fabric, and at least one braid filament or at least one fabric 620 for providing a reinforcing fiber matrix for saturation with an epoxy material, spirally wrapped, applied or braided on the flexible core component.

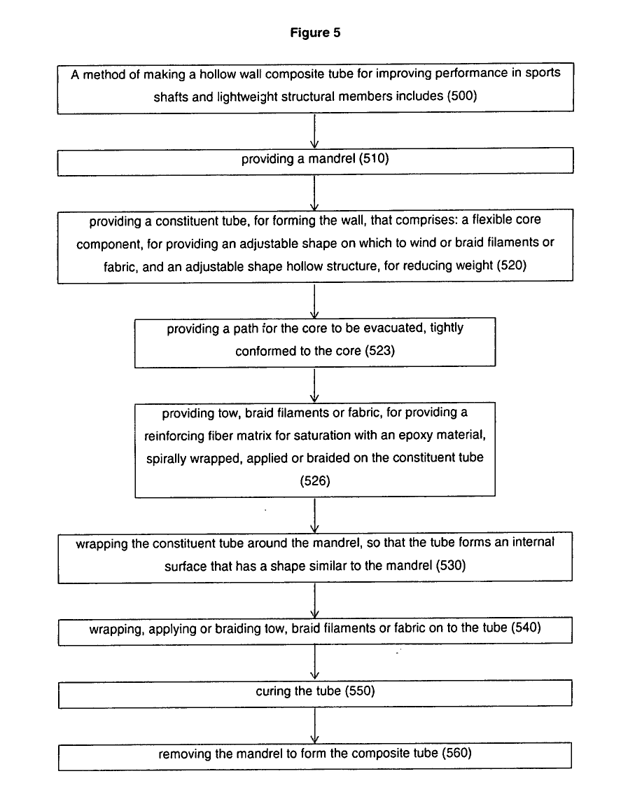

A method 500 of making a curable hollow wall composite tube for improving performance in sports shafts, lightweight applications, and lightweight structural members is also disclosed and shown in FIG. 5 that includes: providing a mandrel 510; providing a constituent tube 520 for forming the wall that comprises: an evacuable flexible core component on which to wind or braid filaments or fabric; providing 526 at least one two, at least one braid filament or at least one fabric for providing a reinforcing fiber matrix for saturation with an epoxy material, spirally wrapped, applied or braided on the flexible core component; providing 523 a path for the core to be evacuated, tightly conformed to the core; wrapping 530 the constituent tube around the mandrel, so that the tube forms an internal surface that has a shape similar to the mandrel; wrapping, applying or braiding 540 two, braid filaments or fabric on to the tube; and removing 560 the mandrel to form the composite tube. In some embodiments, an epoxy material is also provided and included that is applied to or saturates the at least one braid filament or at least one fabric. In this embodiment, there can be an added step of curing 550 the epoxy material.

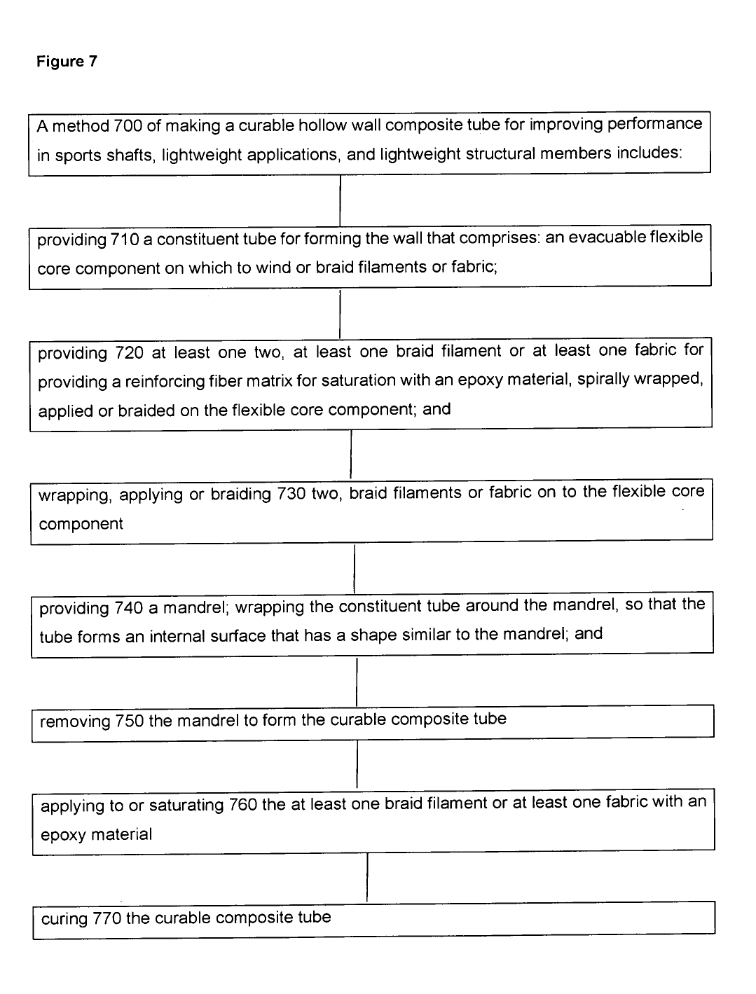

A contemplated method 700 of making a curable hollow wall composite tube for improving performance in sports shafts, lightweight applications, and lightweight structural members is shown in FIG. 7 and includes: providing 710 a constituent tube for forming the wall that comprises: an evacuable flexible core component on which to wind or braid filaments or fabric; providing 720 at least one two, at least one braid filament or at least one fabric for providing a reinforcing fiber matrix for saturation with an epoxy material, spirally wrapped, applied or braided on the flexible core component; and wrapping, applying or braiding 730 two, braid filaments or fabric on to the flexible core component. In some embodiments, the method further comprises: providing 740 a mandrel; wrapping 750 the constituent tube around the mandrel, so that the tube forms an internal surface that has a shape similar to the mandrel; and removing 750 the mandrel to form the curable composite tube. In other embodiments, contemplated methods further comprise applying to or saturating 760 the at least one braid filament or at least one fabric with an epoxy material. In yet other embodiments, contemplated methods further comprise curing 770 the curable composite tube.

In some embodiments, a composite tube “fabric” can be formed from a series of curable hollow wall composite tubes that are laid side-by-side or are wound in such a way that they form a long and/or wide piece of fabric, as shown in FIG. 6. In this instance, the fabric formed by the curable hollow wall composite tubes does not need to be wound around a mandrel, but instead may be applied to another structure or formed in a way that is more freeform.

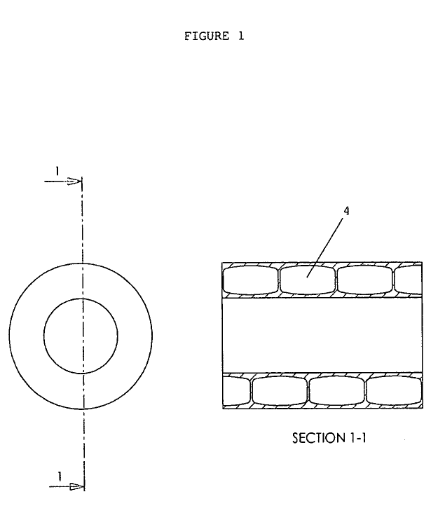

FIG. 1 is a sectional view of a hollow wall composite tube in accordance with contemplated embodiments. This sectional view in FIG. 1 is cut parallel to the axis of the tube. The hollow component or structure 4, which is formed as part of the flexible core component as disclosed herein, shown is arched for strength and may comprise arched internal walls or internal surfaces, like an architectural arch. The shape of the hollow structure 4 can be tuned, sized or structured to optimize performance in a given application. For example, if the tube is to be used as a golf club shaft, subject to severe side loads, the arch shaped hollow structure 4 strengthens the wall against collapse. In contemplated embodiments, hollow wall composite tubes comprise internal or inner surfaces and outer or external surfaces.

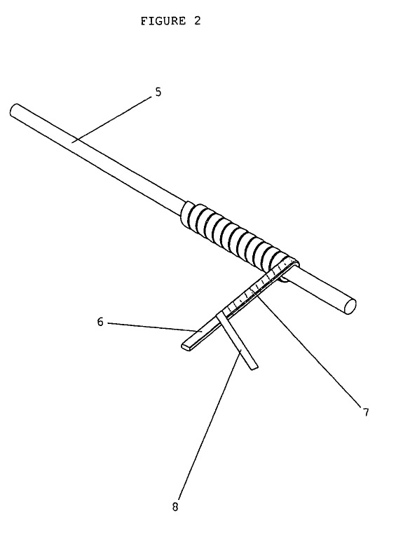

FIG. 2 is a perspective view showing constituent tube 7 being wound onto a removable mandrel 5. Once the mandrel 5 is removed, an adjustable shape hollow base is produced. The hollow base is going to be similar in shape to the mandrel 5, as expected.

Also shown is constituent tube 7 being produced by a spiral wrapping an evacuable flexible core component 6 with tow (filaments) or at least one fabric 8 prior to being wound on mandrel 5. Tuning of the hollow component 4 shape can be accomplished by changing the shape of core component 6. An elongated oval core component 6 will produce an elongated oval hollow 4 after curing in a manner well known to those skilled in the art, and the solid and evacuable flexible core component 6 is removed or converted into the flexible and evacuable core component that comprises a hollow structure 4 by dissolving, melting or otherwise removing at least part of the core component, so that it is at least partially evacuated.

It is important to realize that there are two hollow structures. The first is the hollow structure formed inside of the constituent tube 7 that is shown in FIG. 1. The second is the hollow base that is formed after the mandrel 5, shown in FIG. 2, is removed. In contemplated embodiments and as disclosed above, hollow wall composite tubes comprise internal surfaces and outer or external surfaces, and the internal surfaces can further comprise a layer of fabric or fiber. In other embodiments, the layer of fiber or fabric is conformed to the internal or inner surface.

Likewise, a round or rectangular cross section evacuable flexible core component 6 (wrapped with fabric or filaments to form constituent tube 7) can produce a round or rectangular shaped hollow structure 4. Material used for making the evacuable flexible core component 6 may be wax, foam or Styrofoam, or otherwise meltable or soluble materials. After curing, the core can be melted, dissolved or otherwise removed with the helically traversing hollow providing a path for the core to drain out, leaving hollow structure 4 empty.

If evacuable flexible core component 6 is tubing, it can be pressurized and the mold and mandrel 5 can hold the constituent tube 7 supported by the evacuable flexible core component 6, in a restrained position during the epoxy cure, and the finish cured hollow base will have a shape corresponding to the mold and mandrel 5. At least one layer of flexible core component may be utilized, and in some embodiments, at least two layers of flexible core components may be utilized to form the hollow wall composite tube.

Mandrels are commonly used for the “layup” of composite fiber fabric, or filament winding of composite fiber in the manufacture of composite tubes. Typically carbon fiber filaments (called “tow”) or carbon fiber fabric is used, though other fibers and fabrics are also used. In a common method of producing composite tubing, tow or fabric is wrapped on the mandrel already “wetted out” (called a “prepreg”) or encapsulated later, by injecting epoxy into the mold used to encapsulate the fibers and/or fabric.

In the manufacture of golf shafts, these mandrels are tapered and coated with mold release or wax to facilitate easy removal. The mandrel forms the internal surface of the tube, referred herein as the “hollow base”, and typically a mold forms the outer surface of the tube. Mandrels can be made from hardened steel or other metal and reused. Contemplated embodiments disclosed herein may have a ribbed interior on its inner surface, in the form of a shallow helical groove if constituent tube 7 is crowned, which is due to the helical track formed by constituent tube 7 having been spirally wound on mandrel 5. In other embodiments, a mandrel may not be used, but instead a surface or another shaped material can be used in order to form the material or component application.

If the hollow structure 4 is crowned or arched as shown in FIG. 1, there will be a small valley where the crowned winds of constituent tube 7 are tangent to each other. If the small valley on the internal surface of the finished tube is “unfilled” and thus the internal surface has ribs, then mandrel 5 extraction can be facilitated by rotating it and unscrewing it from the finished product—leaving the internal surface unfilled and thus helically ribbed, creating a slightly lighter structure without affecting aerodynamics if the shaft is to be swung through the air as with a golf shaft.

Or the ribbed inner surface of the tube to be produced may be filled between the crowned tops of the winds with fill or just epoxy. This would produce a smooth inner surface in the finished tube. In this case, the mandrel 5 can be extracted by pulling it straight out axially after curing in a manner well known to those skilled in the art. In contemplated embodiments, internal surfaces, external surfaces or a combination thereof of contemplated hollow wall composite tubes may be coated with, embedded with, saturated with or sprayed with an epoxy material.

To strengthen and fill between the crowned areas of the constituent tube 7, a narrow strip or strips of fiber or fabric can be wound on the mandrel 5 before the constituent tube is wound onto mandrel 5, which can produce a smoother inside surface. Constituent tube 7 would necessarily be wound such that the crowned portion (if the preferred shape of hollow 4 is crowned) lies between the fill. So fill, consisting of stitching or fiber or fabric or any combination thereof, bridges the valley between the winds, and strengthens the area that would be prone to stress concentration.

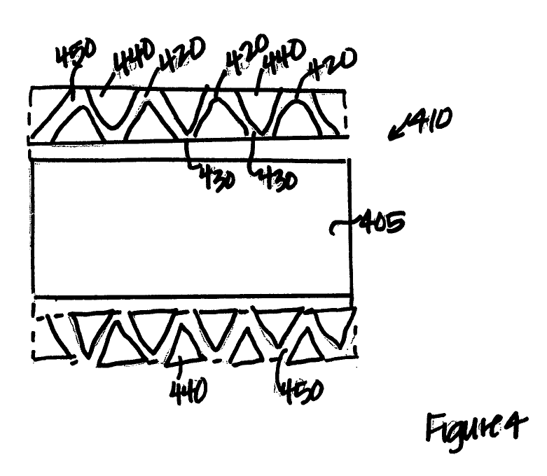

Contemplated fill may also comprise an additional constituent tube, as shown in FIG. 4, for example, if a triangular cross section constituent tube 410 is wound on the mandrel 405, the peaks 420 of the triangle will leave significant valleys 430 in between each wind around the mandrel. These peaks can be filled by another layer 440 of the same constituent tube, wherein it is inverted to put the peaks of the second layer in the valleys of the first layer. An epoxy or filler 450 may be used to adhere the layers to one another or to fill in the crevices between the layers.

If the evacuable flexible core component 6 is not pressurized with fluid or air, the winds of the constituent tube 7 can be stitched together with carbon fiber thread, aramid fiber thread, or other suitable thread. This stitching can be done while constituent tube 7 is wound on the mandrel 5 or in combination with a strip or strip of tow or fabric 8 to fill the small unfilled area between the ribs, in accordance with the disclosures in the provisional patent applications 61/656,010 and 61/671,700, which form part of the basis for priority for this application.

If the unfilled area on the outer surface is filled by strips of fabric or stitching, or both, the fiber content of the finished composite tube will be greater, resulting in higher strength. Likewise fill can be added in the helically traversing valley on the outer surface of the pre-molded tube that would be formed by using a crowned core 6 inside constituent tube 7.

Further strengthening of the outer surface can be accomplished by wrapping, in a manner well known to those skilled in the art, with carbon fiber fabric or filament winding or any combination, forming an outer sleeve. Likewise strengthening of the inner surface can be accomplished by wrapping the mandrel 5 with fabric or fiber before the constituent tube 7 is deposited on it, forming an inner sleeve.

In FIG. 2, an end portion of constituent tube 7 is shown extended into the foreground, containing evacuable flexible core component 6. In the finished product, this extended portion would not be present. Both ends would be cut perpendicular to the tube axis like a standard tube cut to length. Contemplated embodiments wound construction is in accordance with the disclosures of provisional patent applications 61/656,010, 61/606,186, and 61/671,700, specifically FIG. 1 of each of the three listed provisional applications.

Both FIGS. 1 and 2 show a random length of contemplated embodiments.

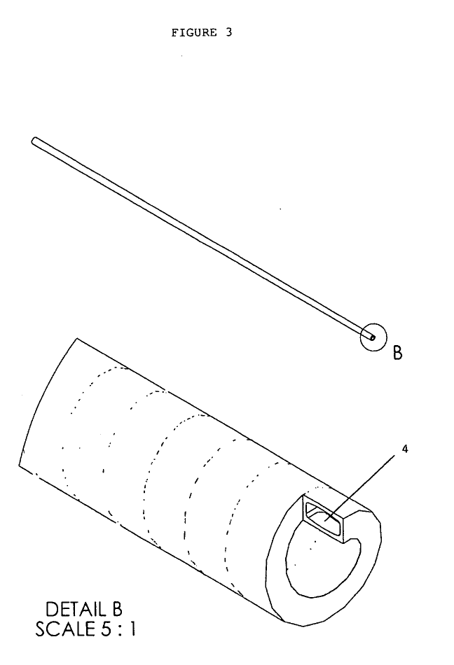

FIG. 3 shows a contemplated embodiment configured as a golf shaft, mandrel 5 having been removed and evacuable flexible core component 6 melted, partially melted, or dissolved out or bonded in. In the case of many golf shafts, the tube would be about 46 inches long. The gripped end would be approximately ⅝″ diameter for an adult golf club, tapering smaller toward the clubhead end in the foreground.

Thus, having suitable epoxy, tow and/or fabric, evacuable flexible core material, a mandrel and mold, those skilled in the art can wind the tow or fabric on a shaped core, wind that wrapped core around a mandrel, and clamp the assembly in a mold, the fiber having been pre-impregnated or to be encapsulated by epoxy injection while in the mold.

After epoxy cure, the mandrel can be removed and the core liquefied and drained out (or in the opposite order), or in the case of a bonded in-core, pressure is turned off to the core. Then, the mold is opened, and the finished tube removed from the mold. The mold may be opened any time after full cure, but for dimensional stability, it is usually preferable to open it as the last operation.

Thus, specific embodiments, methods of producing and utilizing hollow wall composite tubes, methods of production and uses thereof have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification and claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A curable hollow wall composite tube for improving performance in sports shafts, lightweight applications, and lightweight structural members, comprising:
a constituent tube, for forming the hollow wall composite tube, that comprises an evacuable flexible core component on which to wind or braid filaments or fabric, and
at least one braid filament or at least one fabric for providing a reinforcing fiber matrix for saturation with an epoxy material, spirally wrapped, applied or braided on the flexible core component.

2. The hollow wall composite tube of claim 1, wherein the evacuable flexible core component is evacuated.

3. The hollow wall composite tube of claim 1, wherein the curable hollow wall composite tube is cured.

4. The hollow wall composite tube of claim 1, wherein the constituent tube comprises an internal surface and an outer surface.

5. The hollow wall composite tube of claim 4, wherein the internal surface further comprises a layer of fabric or fiber.

6. The hollow wall composite tube of claim 5, wherein the layer of fabric or fiber is conformed to the internal surface.

7. The hollow wall composite tube of claim 4, wherein the internal surface, the external surface or a combination thereof is coated with an epoxy material.

8. The hollow wall composite tube of claim 4, wherein the internal surface, the external surface or a combination thereof is saturated with an epoxy material.

9. The hollow wall composite tube of claim 1, wherein there is at least one layer of evacuable flexible core component.

10. The hollow wall composite tube of claim 1, wherein there is at least two layers of evacuable flexible core component.

11. The hollow wall composite tube of claim 1, wherein the tube is used as part of a golf club, a tennis racket, a ski pole, a hockey stick, a fishing rod, or an arrow.

12. The hollow wall composite tube of claim 1, wherein the tube is used as part of an aerospace component, a sailboat, an automobile, or a bicycle.

13. A method of making a curable hollow wall composite tube for improving performance in sports shafts, lightweight applications, and lightweight structural members comprises:
providing a constituent tube for forming the wall that comprises:
an evacuable flexible core component on which to wind or braid filaments or fabric;
providing at least one two, at least one braid filament or at least one fabric for providing a reinforcing fiber matrix for saturation with an epoxy material, spirally wrapped, applied or braided on the flexible core component; and
wrapping, applying or braiding two, braid filaments or fabric on to the flexible core component.

14. The method of claim 13, wherein the method further comprises:
providing a mandrel;
wrapping the constituent tube around the mandrel, so that the tube forms an internal surface that has a shape similar to the mandrel; and
removing the mandrel to form the curable composite tube.

15. The method of claim 14, further comprising applying to or saturating the at least one braid filament or at least one fabric with an epoxy material.

16. The method of claim 15, further comprising curing the curable composite tube.

17. The method of claim 13, wherein there is at least one layer of evacuable flexible core component.

18. The method of claim 13, wherein there is at least two layers of evacuable flexible core component.
